(19) United States
(12) Patent Application Publication
(10) Pub. No.: US 2026/0014946 A1
(43) Pub. Date: Jan. 15, 2026

(54) VEHICLE

(71) Applicant: Isuzu Motors Limited, Yokohama-shi (JP)

(72) Inventor: Yuya HAGIHARA, Fujisawa-shi (JP)

(73) Assignee: Isuzu Motors Limited, Yokohama-shi (JP)

(21) Appl. No.: 19/262,192

(22) Filed: Jul. 8, 2025

(30) Foreign Application Priority Data
Jul. 9, 2024 (JP) 2024-110436

(51) Int. Cl. B60R 16/037; B60H 1/00; B60Q 5/00; E05F 15/73

(52) U.S. Cl. CPC B60R 16/037; B60H 1/00742; B60Q 5/005; E05F 15/73; E05Y 2400/528; E05Y 2900/531; E05Y 2900/55

(57) ABSTRACT

The vehicle of the present disclosure includes a left-behind detection section that detects whether or not a person is left behind in a vehicle, and a life prolongation control section that, when the left-behind detection section detects that the person is left behind, causes a plurality of life-prolongation-related sections of the vehicle to be activated stepwise according to an elapsed time after the person is left behind.

### CROSS REFERENCE TO RELATED APPLICATIONS

This application claims the benefit of priority of Japanese Patent Application No. 2024-110436, filed on Jul. 9, 2024, the contents of which are incorporated by reference as if fully set forth herein in their entirety.

### TECHNICAL FIELD

The present disclosure relates to a vehicle capable of ensuring safety of an infant, a child, and/or the like left behind in a vehicle.

### BACKGROUND ART

Accidents occur in which, when a driver gets out of a passenger car or bus and unintentionally leaves an infant or child who was riding together behind in the vehicle (hereinafter, leaving the infant or child behind in the vehicle may simply be referred to as “leaving-behind”), the child is left unattended, resulting in the child being in a dangerous physical condition, and in the worst case, losing their life.

In order to prevent such accidents, there has been proposed a technique of notifying a driver or emergency services capable of coping with the leaving-behind when the leaving-behind is detected, for example, as described in Patent Literature (hereinafter referred to as “PTL”) 1.

Further, as described in, for example, PTL 2, a technique has been proposed in which, upon detection of leaving-behind, not only is a notification provided to a driver or the like, but also an air conditioner or similar device is activated to improve the vehicle interior environment and thereby ensure the safety of an infant or child who has been left behind.

### CITATION LIST

### Patent Literature

PTL 1
Japanese Patent Application Laid-Open No. 2020-004242
PTL 2
Japanese Patent Application Laid-Open No. 2015-147105

### SUMMARY OF INVENTION

### Technical Problem

Meanwhile, in a method using the notification to the driver, there is a possibility that the driver does not notice the notification. In addition, in a method using the notification to the emergency services, there is a concern that the emergency services must frequently dispatch to the rescue. Emergency services are mostly public agencies, and frequent rescue operations can be a significant social burden.

Further, in a method of activating an air conditioner or the like, the operation time of the air conditioner depends on the remaining amount of battery power and gasoline, and it is not always possible to maintain the interior environment comfortably for a long period of time.

As described above, the conventional measures against leaving-behind have not been fully developed with sufficient consideration for the capabilities of the vehicle or its surroundings, and are therefore considered to have room for improvement.

The present disclosure provides a vehicle capable of saving an infant, a child, and/or the like left behind in a vehicle more accurately and safely than a conventional vehicle.

### Solution to Problem

One aspect of a vehicle of the present disclosure includes:
a left-behind detection section that detects whether or not a person is left behind in a vehicle; and
a life prolongation control section that, when the left-behind detection section detects that the person is left behind, causes a plurality of life-prolongation-related sections of the vehicle to be activated stepwise according to an elapsed time after the person is left behind.

### Advantageous Effects of Invention

According to the present disclosure, an infant, a child, and/or the like left behind in a vehicle can be saved more accurately and safely as compared to the conventional techniques.

### BRIEF DESCRIPTION OF DRAWINGS

FIG. 1 is a block diagram showing a configuration of a vehicle according to an embodiment; and

FIG. 2 is a flowchart illustrating a flow of life prolongation control in the vehicle according to the embodiment.

### DESCRIPTION OF EMBODIMENTS

Hereinafter, embodiments of the present disclosure will be described in detail with reference to the drawings.

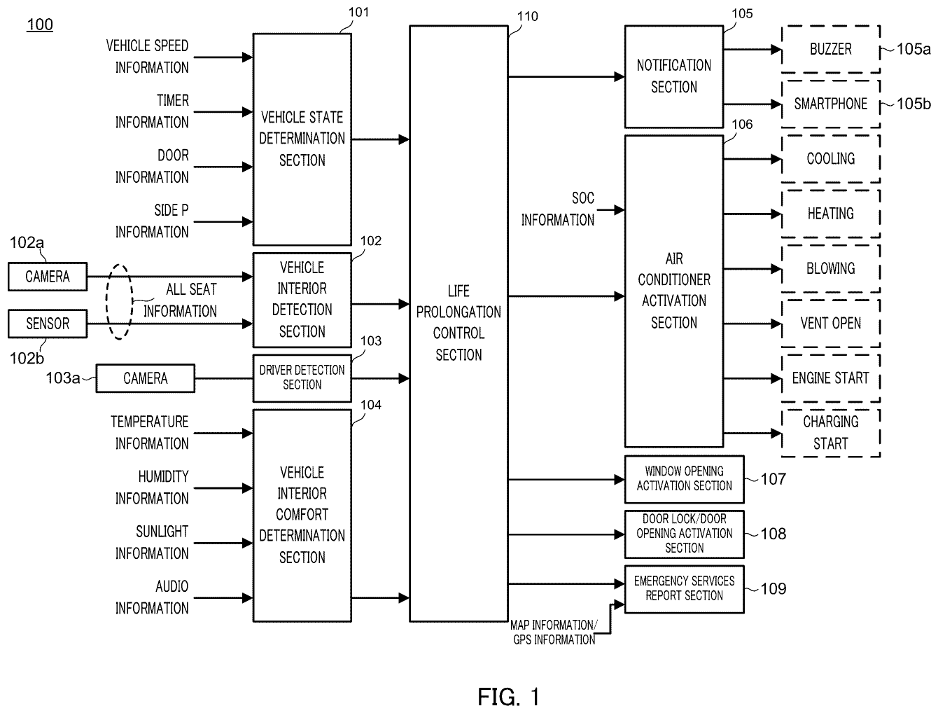

FIG. 1 is a block diagram illustrating a configuration of vehicle 100 according to an embodiment of the present disclosure. Vehicle 100 is a passenger car, a bus, or the like.

Vehicle 100 includes vehicle state determination section 101, vehicle interior detection section 102, driver detection section 103, vehicle interior comfort determination section 104, life prolongation control section 110, notification section 105, air conditioner activation section 106, window opening activation section 107, door lock/door opening activation section 108, and emergency services report section 109.

Vehicle state determination section 101 receives inputs of vehicle speed information, timer information, door information, and parking brake information (side P information), and determines whether or not vehicle 100 is in a parking state based on these pieces of information. Vehicle state determination section 101 determines that vehicle 100 is in the parking state when, for example, 10 minutes or more elapse since the vehicle speed becomes 0 km/h, the door is entirely closed, and the parking brake is activated.

Vehicle interior detection section 102 receives all-seat information from camera 102a and sensor 102b, and determines whether or not there is a person in the vehicle based on the information.

Driver detection section 103 determines whether or not there is a person in a driver seat based on the information of camera 103a.

Vehicle interior comfort determination section 104 receives inputs of temperature information in the vehicle, humidity information in the vehicle, sunshine information in the vehicle, and sound information in the vehicle, and determines vehicle interior comfort based on these pieces of information.

By way of example, vehicle interior comfort determination section 104 determines the vehicle interior comfort based on the following:
<1> the temperature is 22° C. or lower, and the humidity is 55% or lower (determination of being cold);
<2> the temperature is 28° C. or higher, and the humidity is 60% or higher (determination of being hot);
<3> the illuminance exceeds 10,000 1× (direct sunlight); and
<4> the presence of 4000 Hz sounds (crying sound of an infant).

For example, when any one of <1> to <4> is detected, vehicle interior comfort determination section 104 determines that the vehicle interior is not comfortable.

Life prolongation control section 110 controls notification section 105, air conditioner activation section 106, window opening activation section 107, door lock/door opening activation section 108, and emergency services report section 109 as life-prolongation-related sections, based on outputs from vehicle state determination section 101, vehicle interior detection section 102, driver detection section 103, and vehicle interior comfort determination section 104.

Life prolongation control section 110 includes, as main components, a Central Processing Unit (CPU), a Read Only Memory (ROM), a Random Access Memory (RAM), and the like. The CPU reads a program corresponding to process content from the ROM, develops the program in the RAM, and collectively controls operations of notification section 105, air conditioner activation section 106, window opening activation section 107, door lock/door opening activation section 108, and emergency services report section 109 in cooperation with the developed program. All or part of life prolongation control section 110 may be formed from a hardwired circuit such as an Application Specific Integrated Circuit (ASIC) or a Field-Programmable Gate Array (FPGA). The control by life prolongation control section 110 will be described in detail later.

Notification section 105 provides, in surroundings of vehicle 100 and/or to the driver of vehicle 100, a notification of occurrence of leaving-behind based on a control signal from life prolongation control section 110. For example, when a notification request is inputted from life prolongation control section 110, notification section 105 sounds buzzer (which may be referred to as a security alarm) 105a for 30 seconds. In addition, notification section 105 notifies smartphone 105b of the driver of an email a total of three times, for example, at intervals of 10 minutes. As a result, it is possible to notify a person and a driver in the vicinity of vehicle 100 that leaving-behind has occurred.

Air conditioner activation section 106 operates the air conditioner based on a control signal from life prolongation control section 110. At this time, air conditioner activation section 106 performs the following operations <1> to <4>.

<1> An input of State Of Charge (SOC) information is received, and whether or not the SOC is 90% or more is determined.

<2> When the SOC is less than 90%, an engine is started in the case of a vehicle equipped with the engine, and the charge is started in the case of an electric vehicle (which includes a Battery Electric Vehicle (BEV), Hybrid Electric Vehicle (HEV), Plug-in Hybrid

Electric Vehicle/Plug-in Hybrid Vehicle (PHEV/PHV), Fuel Cell Electric Vehicle/Fuel Cell Vehicle (FCEV/FCV)).

<3> When a cooling activation request is received from life prolongation control section 111, a vent opening control is first performed (since the effect of cooling is reduced when the vent is artificially closed). Thereafter, the cooling and blowing are activated so as to reach the target temperature.

<4> When a heating activation request is received from life prolongation control section 110, the vent opening control is performed first (since the effect of heating is reduced when the vent is artificially closed). Thereafter, the heating and blowing are activated so as to reach the target temperature.

Window opening activation section 107 opens a window of vehicle 100 based on a control signal from life prolongation control section 110. For example, when receiving a window opening request from life prolongation control section 110, window opening activation section 107 opens the window of all the seats by 5 cm. As described above, by opening the window to the extent that a temperature rise in the vehicle interior can be mitigated without fully opening the window, it is possible to suppress the temperature rise in the vehicle interior while suppressing the security decrease such as vehicle break-in.

Door lock/door opening activation section 108 releases a door lock of vehicle 100 or opens the door based on a control signal from life prolongation control section 110. Specifically, door lock/door opening activation section 108 releases the door lock of all the seats when the door lock release request is received from life prolongation control section 110. Further, in the case of a bus, door lock/door opening activation section 108 opens the door of the front door and/or the middle door when a door unlock request is received from life prolongation control section 110. This makes it easier for a person who has been left behind to escape from the inside of the vehicle, and also makes it easier for a person in the vicinity to rescue the person who has been left behind.

Emergency services report section 109 notifies the emergency services, such as a fire department, of the occurrence of leaving-behind and the information on a place thereof by, for example, making an emergency services report via a telephone call or an Internet line, based on a control signal from life prolongation control section 110. Here, the information on the location notified to the emergency services by emergency services report section 109 is, for example, information (map information) on a map of vehicle 100 in which the leaving-behind has occurred, information (GPS information) on the latitude and longitude of vehicle 100, and the like.

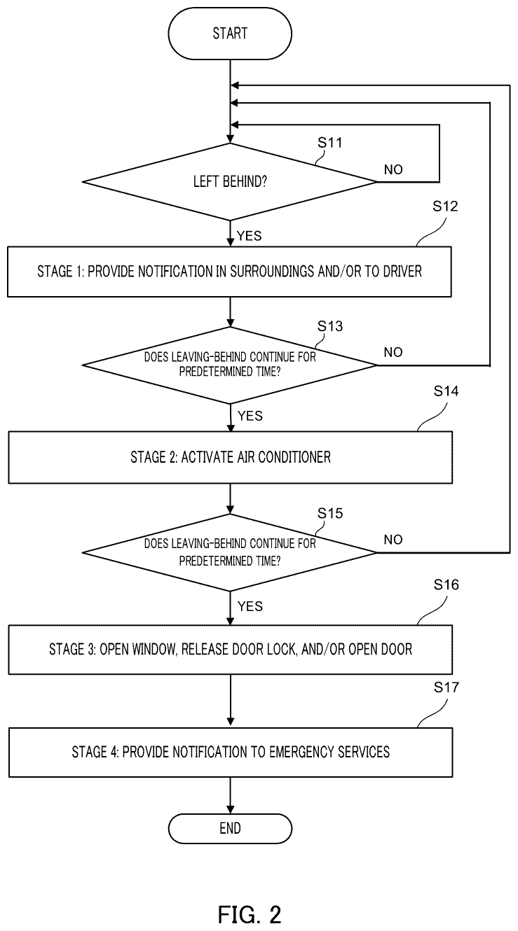

Next, an operation of the present embodiment will be described. FIG. 2 is a flowchart showing a flow of life prolongation control of vehicle 100 according to the present embodiment.

When the life prolongation control process is started, life prolongation control section 110 first determines in step S11 whether or not leaving-behind has occurred. Specifically, life prolongation control section 110 determines that leaving-behind has occurred when vehicle state determination section 101 determines parking, vehicle interior detection section 102 obtains a detection result indicating that a person is in the vehicle, and when driver detection section 103 obtains a detection result indicating that no person is in the driver seat, and the process proceeds to step S12 (step S11; YES).

In step S12, stage 1 life prolongation control is performed. In step S12, life prolongation control section 110 controls notification section 105 to sound buzzer 105a of vehicle 100 or to notify smartphone 105b of the driver of an e-mail, thereby notifying that leaving-behind has occurred. It should be noted that buzzer 105a may be sounded first, and if the leaving-behind is not solved, a notification may be provided to the smartphone of the driver next.

In step S13, life prolongation control section 110 determines whether or not leaving-behind continues for a predetermined period of time, and when it is determined that leaving-behind is continued, the process proceeds to step S14 (step S13; YES), and when it is determined that leaving-behind is not continued, the process returns to step S11 (step S13; NO). Here, the predetermined time may be, for example, a time set in advance by the user, or may be changed in accordance with a determination result by vehicle interior comfort determination section 104. For example, it is preferable that the predetermined time be shorter as the temperature in the vehicle is higher, the light incident in the vehicle is larger, and the crying sound of the infant is larger.

In step S14, stage 2 life prolongation control is performed. In step S14, life prolongation control section 110 controls air conditioner activation section 106 to control cooling or heating so that the vehicle interior temperature becomes comfortable. At this time, air conditioner activation section 106 starts the engine or charges the battery in accordance with the remaining battery capacity (SOC) in order to satisfactorily perform cooling or heating.

In step S15, life prolongation control section 110 determines whether or not leaving-behind continues for a predetermined period of time, and when it is determined that leaving-behind is continued, the process proceeds to step S16 (step S15; YES), and when it is determined that leaving-behind is not continued, the process returns to step S11 (step S15; NO). Here, the predetermined time may be, for example, a time set in advance by the user, or may be changed in accordance with the remaining amount of energy for operating the air conditioner. For example, the smaller the remaining amount of energy for operating the air conditioner, the shorter the predetermined time.

In step S16, stage 3 life prolongation control is performed. In step S16, life prolongation control section 110 controls window opening activation section 107 and door lock/door opening activation section 108 to open the window, unlock the door, and/or open the door. As a result, the outside air can be taken into the vehicle even when the air conditioner is stopped. As a result, an increase in the vehicle interior temperature can be suppressed. In addition, the person who is left behind can easily escape to the outside of the vehicle by himself/herself, or a person around vehicle 100 can easily rescue the person who is left behind.

In step S17, stage 4 life prolongation control is performed. In step S17, life prolongation control section 110 notifies the emergency services (ambulance, fire department, or police) of a request for rescue by emergency services report section 109 or the like. In this way, the notification to the emergency services is made after the notification to the driver and the improvement of the vehicle interior comfort by the air conditioner, so that frequent dispatch of the emergency services can be suppressed.

Note that the process of step S17 may be performed at the same time as step S16, or may be performed prior to step S16 and after step S15. In this way, the time for the emergency services to arrive at vehicles 100 is accelerated, and the time for which security is deteriorated due to performing step S16 can be shortened.

Vehicle 100 of the present embodiment has the following configuration.

(1) One aspect of vehicle 100 of the present disclosure includes a left-behind detection section (vehicle state determination section 101, vehicle interior detection section 102, and driver detection section 103) that detects whether or not a person is left behind in vehicle 100, and life prolongation control section 110 that, when leaving-behind is detected by the left-behind detection section (vehicle state determination section 101, vehicle interior detection section 102, and driver detection section 103), causes a plurality of life-prolongation-related sections (notification section 105, air conditioner activation section 106, window opening activation section 107, door lock/door opening activation section 108, and/or emergency services report section 109) of vehicle 100 to be activated stepwise according to the elapsed time after leaving-behind.

Accordingly, it is possible to realize vehicle 100 capable of saving an infant, a child, and/or the like left in the vehicle more accurately and safely than in the conventional techniques.

(2) In one aspect of vehicle 100 of the present disclosure, the life-prolongation-related sections (notification section 105, air conditioner activation section 106, window opening activation section 107, door lock/door opening activation section 108, and/or emergency services report section 109) include air conditioner activation section 106 and an opening activation section (window opening activation section 107 and/or door lock/door opening activation section 108) for the window and/or the door, and life prolongation control section 110 performs a turning-on operation on an air conditioner via air conditioner activation section 106 and, subsequently after a lapse of a predetermined time, performs an opening operation on the window and/or the door via the opening activation section (window opening activation section 107 and/or door lock/door opening activation section 108).

Thus, the air conditioner makes the inside of the vehicle comfortable, and further, the window and the door are opened even when the air conditioner becomes incapable of being activated, so that the life prolongation operation can be maintained.

(3) In one aspect of vehicle 100 of the present disclosure, the life-prolongation-related section (notification section 105, air conditioner activation section 106, window opening activation section 107, door lock/door opening activation section 108, and/or emergency services report section 109) includes first notification section 105 for providing a notification of leaving-behind in surroundings of vehicle 100 and/or to a driver of vehicle 100, and a second notification section (emergency services report section) for providing a notification of leaving-behind to the emergency services, and the notification by the second notification section (emergency services report section) is provided after the notification by first notification section 105.

As a result, frequent dispatch of the emergency services can be suppressed.

(4) In one aspect of vehicle 100 of the present disclosure, the life-prolongation-related sections (notification section 105, air conditioner activation section 106, window opening activation section 107, door lock/door opening activation section 108 and/or emergency services report section 109) include air conditioner activation section 106, an opening activation section (window opening activation section 107 and/or door lock/door opening activation section 108) for the window and/or door, first notification section 105 for providing a notification of leaving-behind in surroundings of vehicle 100 and/or to a driver of vehicle 100, and a second notification section (emergency services report section) for providing a notification of leaving-behind to the emergency services, and life prolongation control section 110 performs the notification by first notification section 105, the turning-on operation of the air conditioner by air conditioner activation section 106, the opening operation of opening activation section (window opening activation section 107 and/or door lock/door opening activation section 108), and the notification by the second notification section (emergency services report section) sequentially in an order presented.

As a result, it is possible to perform life prolongation control in an appropriate order in which assistance by an unrelated person is suppressed as much as possible and decrease in security is suppressed as much as possible.

(5) One aspect of vehicle 100 of the present disclosure further includes vehicle interior comfort determination section 104 that determines the comfort in vehicle 100, in which when a determination result that a life prolongation operation is necessary is obtained by vehicle interior comfort determination section 104, life prolongation control section 110 causes the life-prolongation-related sections (notification section 105, air conditioner activation section 106, window opening activation section 107, door lock/door opening activation section 108, and/or emergency services report section 109) to perform the life prolongation operation.

As a result, the life prolongation operation can be performed only when the comfort in the vehicle is deteriorated, so that no unnecessary life prolongation operation is performed. The embodiment described above merely describes an example of implementations

for practicing the present invention, and should not be construed as limiting the technical scope of the present invention. That is, the present invention can be embodied in various forms without departing from the spirit, scope, or principal features of the present invention.

In the above-described embodiment, the case where the parking state is determined by vehicle state determination section 101 has been described, but the determination processing of vehicle state determination section 101 may be omitted. That is, leaving-behind may be determined from absence of a driver and presence of a person in the vehicle.

### INDUSTRIAL APPLICABILITY

The present disclosure relates to a vehicle capable of ensuring safety of an infant, a child, and/or the like left behind in a vehicle.

### REFERENCE SIGNS LIST

100 Vehicle
101 Vehicle state determination section
102 Vehicle interior detection section
103 Driver detection section
104 Vehicle interior comfort determination section
105 Notification section
106 Air conditioner activation section 106
107 Window opening activation section
108 Door lock/door opening activation section
109 Emergency services report section

1. A vehicle, comprising:
a left-behind detection section that detects whether or not a person is left behind in a vehicle; and
a life prolongation control section that, when the left-behind detection section detects that the person is left behind, causes a plurality of life-prolongation-related sections of the vehicle to be activated stepwise according to an elapsed time after the person is left behind.

2. The vehicle according to claim 1, wherein:
the plurality of life-prolongation-related sections include an air conditioner activation section and an opening activation section for a window and/or a door, and
the life prolongation control section performs a turning-on operation on an air conditioner via the air conditioner activation section and, subsequently after a lapse of a predetermined time, performs an opening operation on the window and/or the door via the opening activation section.

3. The vehicle according to claim 1, wherein:
the plurality of life-prolongation-related sections include a first notification section for providing a notification in surroundings of the vehicle and/or to a driver of the vehicle, and a second notification section for providing a notification to emergency services, the notifications notifying that the person is left behind, and
the notification by the second notification section is provided after the notification by the first notification section.

4. The vehicle according to claim 1, wherein:
the plurality of life-prolongation-related sections include an air conditioner activation section, an opening activation section for a window and/or a door, a first notification section for providing a notification in surroundings of the vehicle and/or to a driver of the vehicle, and a second notification section for providing a notification to emergency services, the notifications notifying that the person is left behind, and
the life prolongation control section performs the notification by the first notification section, a turning-on operation of an air conditioner by the air conditioner activation section, an opening operation by the opening activation section, and the notification by the second notification section sequentially in an order presented.

5. The vehicle according to claim 1, further comprising:
a vehicle interior comfort determination section that determines comfort in the vehicle, wherein
when a determination result that a life prolongation operation is necessary is obtained by the vehicle interior comfort determination section, the life prolongation control section causes the plurality of life-prolongation-related sections to perform the life prolongation operation.
